(19) United States
(12) Patent Application Publication
(10) Pub. No.: US 2021/0029967 A1
(43) Pub. Date: Feb. 4, 2021

(54) METHOD AND APPARATUS FOR APPLICATION OF CHEMICAL TREATMENT TO LIVESTOCK

(71) Applicant: Huey Fussell, JR., Ambrose, GA (US)

(72) Inventor: Huey Fussell, JR., Ambrose, GA (US)

(21) Appl. No.: 16/930,309

(22) Filed: Jul. 15, 2020

Related U.S. Application Data
(60) Provisional application No. 62/874,245, filed on Jul. 15, 2019.

(51) Int. Cl. A01K 13/00; A01K 3/00; E06B 11/00

(52) U.S. Cl. CPC A01K 13/003; E06B 11/00; A01K 13/004; A01K 3/00

(57) ABSTRACT

A method and an apparatus for application of chemical treatment to livestock provide a combination chemical roller applicator and livestock sprayer with a gateway to a livestock resource area. A roller applicator imparts a liquid treatment to the nose and face of an animal after lifting a flap attached to the roller. A pump conveys chemical from a reservoir to the roller and sprayer nozzles. The apparatus secures to an existing fence or gate.

### PRIORITY CLAIM

The present invention claims benefit of U.S. provisional patent application No. 62/874,245 filed on Jul. 15, 2019.

### BACKGROUND OF THE INVENTION

### 1. Field of the Invention

This invention relates to disease control for animals. In particular, the invention concerns a chemical dispensing apparatus and method. The apparatus includes a reservoir of chemical, sprayer nozzles, and roller dispensing with pumps and an electric power source. The combination imparts chemical treatment to livestock while entering a livestock watering or feed area.

### 2. Discussion of the Prior Art

Farmers and cattle ranchers desire to protect their animals from disease. Maintaining an animal's health is most efficient. In contrast, the treatment of illness is time-consuming and expensive. Farmers optimize the health of cattle by monitoring nutrition and by controlling for flies, insects, and other pests. Reducing flies and the like decreases cattle exposure to pest-borne disease vectors.

Generally, models that force the animal to get treatment around the head area are best for reducing face fly numbers. Existing methodologies include the application of protectants through back-rubbers, oilers, and dust bags. Other methodologies include ear tags, pour-on treatments, oral treatments, and biological controls. Moreover, routine spraying controls troublesome pests such as horn flies, and, thus, liquid spraying is often the best option. Yet, spray treatments need reapplication after one to two weeks. During warm seasons, spraying animals uses excessive labor. And, spraying requires handling and confinement of cattle. These hurdles disincentivize ranchers from the suggested preventative treatment.

The prior art teaches many attempts to improve the pest control of a herd by improving the application of chemical treatment.

U.S. Pat. No. 5,063,880 to Rock J. Bouthillier teaches an automatic spraying device that detects animals for spraying and times the process for deactivating a pump.

U.S. Pat. No. 3,763,828 to Peter R. Tighe teaches a spray device with a nozzle in a cow's passageway that the cow must step over to pass. The nozzle below the cow sprays upward to spray the cow's udder.

U.S. Pat. No. 4,379,440 to Thedford and Wilson teaches a livestock spray apparatus with a chute structure and rub panel to provide adjustable guidance for directing different sizes of animals through the chute. The apparatus includes a floor structure for solution filtration.

U.S. Pat. No. 4,987,861 to Lemire and Boyer teaches an apparatus for spraying animals that is mounted to an entranceway for animals. It consists of a U-shaped tubular structure.

U.S. Pat. No. 5,367,983 to Pound, Miller, and LeMeilleur teaches a device and method using a vertical support member carrying pesticide applicators that the animal contacts in the course of feeding for control of ticks or other ectoparasites.

U.S. Pat. No. 1,734,035 to Hargraves teaches a combination insecticide applicator and feeder that disperses chemicals onto the animal by agitation.

U.S. Pat. No. 3,941,096 to Mann teaches an insecticide applicator for applying a material to the face, head, and neck area of livestock that includes a hood, supported mineral block, and an insecticide dispensing device such as a porous fabric activated through agitation by the animal.

U.S. Pat. No. 4,580,529 to Wilson teaches a shed housing a feeder box in which the lid of the feeder box activates a sprayer for dispensing insecticide when the door of the feeder box closes.

U.S. Pat. No. 5,056,467 to Schaefer teaches an animal operated insecticide spray delivery system enclosed in a barrel housing. A feeder door activates the spray system, but Schaefer does not teach a mean for automatically dispensing material onto the bridge of the nose of the animal or multiple sprayer positions for delivery of chemical to the shoulders, back chest, belly, and side of an animal.

The prior art above does not teach a self-contained roller and sprayer apparatus that includes a dribbler/roller that automatically rolls along the bridge of the nose of the animal. And, the art does not include a roller in combination with a sprayer configured multiple positions for delivering spray to the shoulders, back chest, belly, and side of the animal positional at a livestock gate for water/food.

There is a continuing need to prevent disease in livestock caused by malnutrition and disease from pests such as flies. The treatment of livestock for nutrition and disease can be time consuming and inefficient. Therefore, a need exists for a livestock applicator and sprayer that operates in combination with an approach gate to water/food following the present invention that further improves upon the art in the field.

### SUMMARY OF THE PRESENT INVENTION

Accordingly, the overall objective of this invention is to provide a novel combination roller applicator and sprayer for livestock that improves efficiency by combining an existing gateway with the process of treating the animals with sprayed and rolled chemicals to deter pests.

The present apparatus is a combination of livestock sprayer with a roller applicator. The apparatus includes spray nozzles about a gate of the apparatus, a roller attached to a door, lifting flat, a reservoir with pumps for conveying insecticide. The entire apparatus includes a combination of the roller and sprayer into a unit with the insecticide reservoir and pump system contained therein. One may situate the spray nozzles at sides of the gate for application along the length of livestock as an animal passes. A roller provided on a lifting flap at the gate imparts chemical, such as insecticide, to the animal.

### Objects

In a first object, the present invention provides an apparatus comprising a combination application roller and livestock sprayer with the present combination of features. In particular, all parts, including a power source, pump, a reservoir for chemicals, control, lifting flap, sprayer components, roller components, and structural components, form a self-contained unit for mounting in a selected position to the entrance of a gate to feeding and watering area for livestock.

In another object, the apparatus is positioned and mounted into an existing gateway.

In another object, an animal pushes a lifting flap upwards to activate a pump and dispense treatment to an animal by rolling and spraying.

In another object, the spraying system delivers liquid treatment to the shoulders, back chest, belly, and sides of an animal along the entire length of the animal as the animal passes.

In another object, an animal pushes a lifting flap in a gated entrance to activate a roller and sprayer delivering liquid onto a roller, and the roller delivers treatment to the nose or face and back of an animal.

In another object, the apparatus includes a top spray nozzle above the feeder door to spray chemicals on the top and side of the animal and a bottom spray nozzle to spray chemicals on the legs and belly of the animal.

In another object, the apparatus includes an internal ten-gallon tank for holding water and chemical.

In another object, the apparatus includes a solar panel and a rechargeable battery providing power to the control.

In another object, the control of the apparatus includes timing means to activate and control the duration of spray.

In another object, the control of the apparatus includes a timer and agitator pump to agitate water or chemical in the tank.

In another object, the gate entrance design limits the visibility of the sprayer nozzles preventing animal fear.

### BRIEF DESCRIPTION OF THE FIGURES

FIG. 1 is a perspective view of an embodiment of the invention of a new combination method and apparatus for application of chemical treatment to livestock that includes a roller applicator and sprayer system.

FIG. 2 is a front view of the invention of FIG. 1, showing the application of a chemical to livestock.

FIG. 3 is a rear view of the invention of FIG. 1 showing the application of a chemical to livestock.

FIG. 4A is a side view of the invention of FIG. 1 showing the application of a chemical to livestock as the animal approaches the roller applicator.

FIG. 4B is a side view of the invention of FIG. 1, showing the application of a chemical to livestock via the roller applicator and spray nozzles as the animal passes through the gateway.

FIG. 5A is a cut-away side view of the invention of FIG. 1, showing the various aspects and features of the exemplary embodiment of the reservoir holding tank with the float switch in on position.

FIG. 5B is a cut-away side view of the invention of FIG. 1, showing the various aspects and features of the exemplary embodiment of the reservoir holding tank with the float switch in off position.

FIG. 6 is a schematic view showing the method for the combination roller applicator gateway and livestock sprayer shown in FIG. 1.

### DETAILED DESCRIPTION OF THE INVENTION

The following description provides the reader with a better understanding of the invention. The description does not limit the invention concerning any element, not otherwise limited by the claims.

The present invention discloses an apparatus and method that provides a combination roller applicator gateway and livestock sprayer. The combination unit transfers a chemical treatment from a liquid reservoir 12 contained in the unit to an animal 10. Chemical transfers using sprayer nozzles 52, 54, 56 and a roller applicator 40 of a roller lift flap 41 while an animal passes through a gateway to a watering or feeding area.

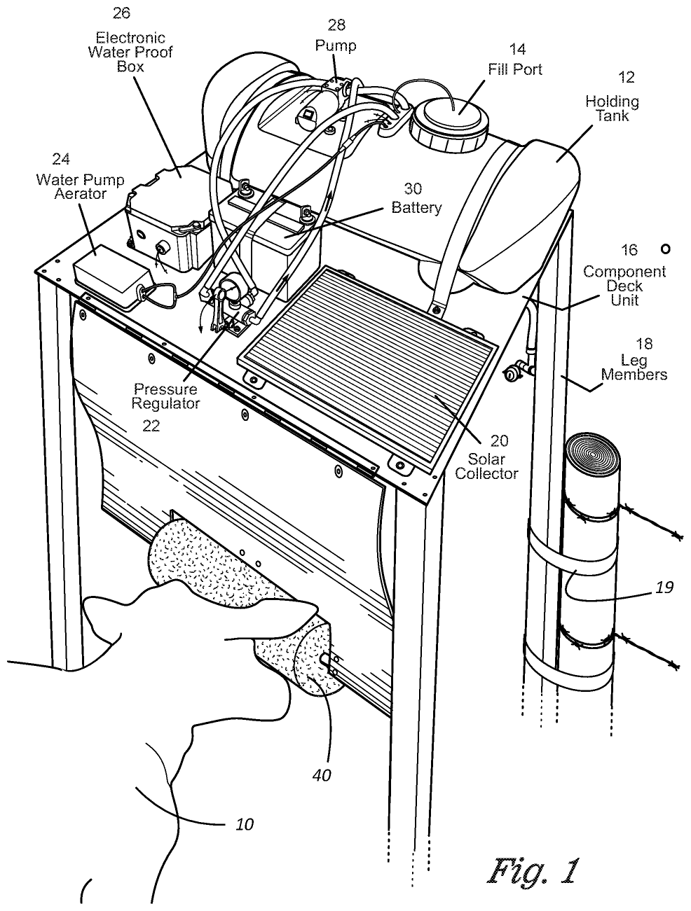

Referring now to the drawings, FIG. 1 shows an apparatus per an embodiment of the invention. The apparatus includes a frame with legs 18 with an overhead support body and upper deck unit 16 that holds the reservoir holding tank 12 and other components. The frame forms the exterior front side, rear side, and opposing left side and right side with legs 18 of the self-contained unit, and the frame mounts to a selected position for access by animals, such as an existing fence or gate. In FIG. 1 the rear legs 18 of the frame as shown attached to an existing fence or gate poles by straps 19. The legs include square members extending vertically and downward from the support body upper deck unit 16. Whereby, the legs extend to the ground, a mat, or another flat surface to rest.

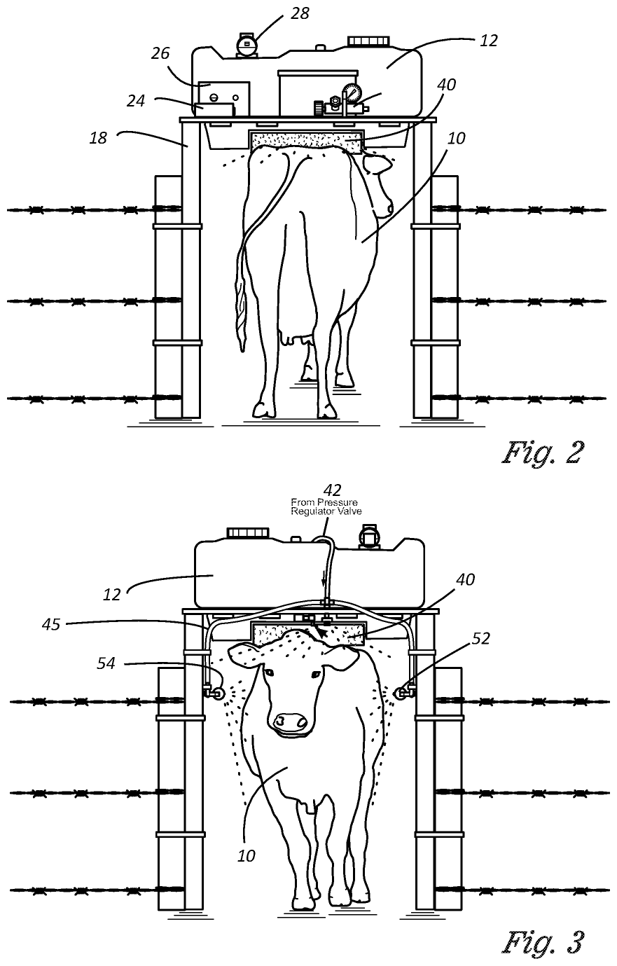

FIG. 2 shows an assembly of the apparatus, self-contained unit parts, and installation of the fence. As shown, the unit 2 mounts to the selected position by installation on the posts. The legs 18 attach by straps 19 or other suitable devices to the fence posts. Alternatively, the legs may be secured to the ground. Alternatively, the legs may secure to a mat comprising a sheet or structure below the apparatus.

The self-contained unit, as shown in the figures, includes a powered control 26 and pump system 28 contained on the overhead support component deck unit 16 of the apparatus. The system includes a combination of electronic control 26, pump 28, and battery 30. The power source is shown in FIG. 1. It includes the battery. In one embodiment, the battery is rechargeable and recharges through a solar panel 20 connected as the power source. The battery connects to the electronic control 26 and the pump 28 to operate the components for dispensing chemical treatment when actuated by an animal 10 via the lift flap 41.

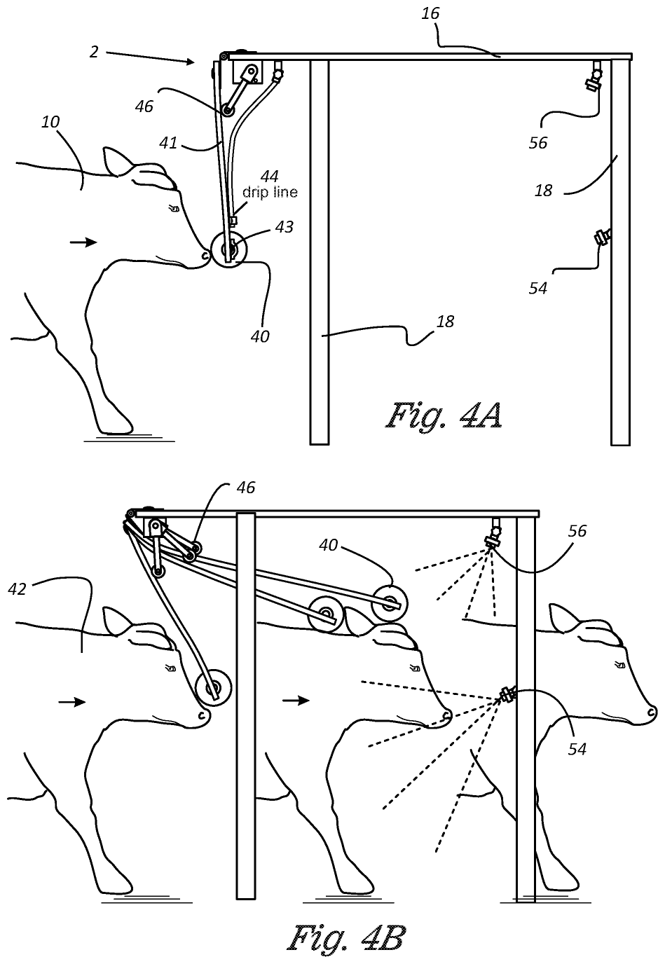

As shown in FIGS. 1, 2, 3, 4A, and 4B, the self-contained unit 2 includes a gateway opening; the animal pushes a lifting flap 41 upward for passage through the gateway to a watering resource, feeding resource, or another desirable resource. When the animal pushes the lifting flap, the movement of the flap moves and initiates a switch 46 that actuates the electronic control 26 that controls the pump and timing of chemical treatment. Alternatively, cameras or other electronic sensors means may determine entry of the animal into the gateway to initiate the electronic control sequence programmed. Upon actuation by the movement of the flap, the electronic control may initiate a timing mechanism in the electronic control 26 to measure and control the duration of a spray of chemicals for treatment of the animal and initiates dispensing of chemicals to the roller applicator 40 of the roller component.

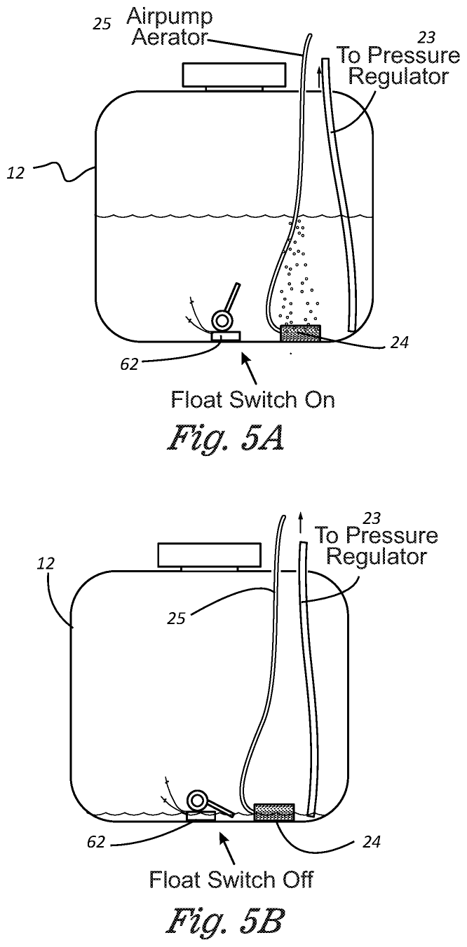

FIGS. 5A and 5B illustrate a float switch 62 in the reservoir of the holding tank 12 that controls the flow of chemicals. The float switch turns off the flow when chemical levels fall below the required levels. A pressure regulator 22 further controls the flow of chemicals from the reservoir via a pressure regulator connecting line 23.

FIGS. 1-4A/B illustrate the sprayer and roller components of the self-contained unit in more detail. Several spray nozzles 52, 54, and 56 are situated about the gateway of the apparatus for application to several areas of the animal's body. A tube 45 connects each nozzle to the pump 28 controlled by the electronic control 26. Each tube transfers chemical from the chemical reservoir 12 to the respective nozzle as determined by actuation by the animal and the control system. The lifting flap entrance design includes a movable hanging flap 41. The flap holds the roller applicator 40. The flap design limits the visibility of the nozzles situated above the animal while the animal enters the gateway head-first to pass. The design prevents the animal from seeing spray emanate from the nozzle and prevents the development of fear of the spray by the animal. The nozzles dispense a spray of chemical treatment to the shoulders, back, chest, and sides of the animal not covered by the roller applicator.

A roller component including the roller applicator 40 attaches near the bottom of the lifting flap 41, whereby the roller applicator is contacted by the animal 10 after the animal proceeds to lift the flap to pass. The roller component includes an axial member 43 for the roller applicator to rotate on as the animal moves the flap further into the open position. Fluid from the chemical and water reservoir dispenses onto the roller applicator via transfer from the reservoir by a tube 44. Like the other tubes for the sprayer nozzles, the amount of fluid dispensed onto the roller applicator depends upon how the electronic control is programmed to activate the pump. As the animal lifts the flap, the animal's nose and bridge of the nose contacts the roller applicator and causes the roller to rotate or press against the animal's skin to deliver treatment to the animal's nose or face and back.

As shown in FIGS. 1-6, the invention provides a new and novel combination lift flap with roller applicator and livestock sprayer with improved features to make the application of insecticide to livestock more convenient. The apparatus includes spray nozzles about the gateway frame of the apparatus, a roller applicator, and a reservoir with pumps for conveying insecticide. The entire apparatus includes a combination of the roller applicator and sprayer into a unit with the insecticide reservoir and pump system contained therein. The spray nozzles may be situated on sides of the gateway formed by the legs of the apparatus. A roller applicator may be provided on the lifting flap of the gateway to impart chemical, such as insecticide, to the animal. The legs of the apparatus may attach to existing poles of a fence for convenient installation.

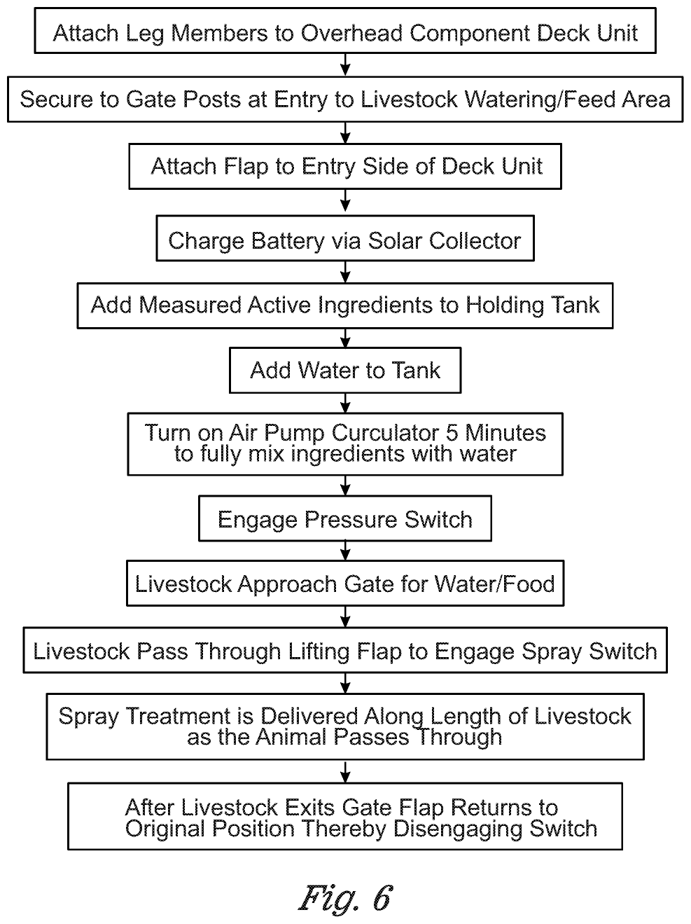

In the method of FIG. 6, a method is schematically illustrated for a combination roller applicator and livestock sprayer. In a first step for setting up a roller applicator and sprayer unit, the combination unit has legs attached to an overhead component deck unit. Next, the apparatus is positioned between gate posts and secured to gate posts at the entrance to a livestock watering/feed area as determined as a location for the treatment of animals. A flap is attached to the entry side of the deck unit. A solar panel collector collects energy and transfers power to a charge a battery or solar battery system on the combination unit. In a sixth step, a chemical and water reservoir provides a treatment tank, and the treatment tank is filled with fluid by adding measured active ingredients to the holding tank and adding water to the tank. An air pump circulator is turned on for five minutes to mix ingredients with the water thoroughly. The pressure switch is engaged. The livestock approach the gate for the passage for water or food. The livestock passes through the lifting flap to engage the spray switch. The spray treatment is delivered along the length of livestock as the animal passes. After livestock exit the gateway, the lifting flap returns to its original position, thereby disengaging the switch. These steps set up the roller/sprayer to provide rolled and spray treatment of animal livestock with chemicals for controlling pests.

Another embodiment includes an automatic sensor camera. The camera films livestock that approaches the sprayer while the animal gets sprayed and as the animal exits the sprayer. The control system is programmable to come on a set time and turn off at a specific time. For example, the system may turn on for three days and remain off for four days of a week. The schedule of operation may repeat itself if desired. The programmable controller may include an electronic system for keeping records of each animal as they go through the sprayer and get sprayed. The electronic control may include further controls and communication modules to turn on or off the sprayer by phone or computer. The control may send messages comprising information about pests, including when flies or other external parasites reach a certain number on the animal body. Information may be communicated to the operator by phone or computer. The control may provide automatic operation and turn on and spray the animal when a certain number of flies or other external parasites are on the animal. As the animal goes through the sprayer, the control may be programmed to give the animal a stress test. For example, as the animal goes through the sprayer, it may perform a heat test on the animal. The control may further include communication by phone or computer to turn on or off the sprayer and set the time to spray and the time to stop spraying. The control may further include communication and measure devices to send automatic messages by phone or computer when the tank gets low or to transmit chemical levels. The control may be automatically set to spray individual animals when flies reach a certain number on the animal or keep the unit turned off when the number of pests does not reach the required number. For example, out of three animals, the first one that has over the set number to be sprayed will cause the unit to turn on and spray the animal. Other animals that do not meet the set number of pests may not cause the sprayer to operate and spray the animals.

These and other embodiments are disclosed by the annotation and figures included in this specification. Further, other embodiments may be apparent to those skilled in the art and within the scope of the invention.

1. An apparatus for application of chemical treatment to livestock comprising:
a. a frame defining a gateway for livestock;
b. a reservoir for the chemical treatment, a pump, and an electronic control supported on the frame;
c. a combination lifting flap and roller applicator supported on the frame;
d. sprayer nozzles supported on the frame; and
e. a switch initiated by the lifting flap when the livestock enters the gateway and said switch causing the electronic control to initial release of the chemical treatment on the livestock through combination of the roller application and the sprayer nozzles.
